(19) United States
(12) Patent Application Publication
(10) Pub. No.: US 2026/0138457 A1
(43) Pub. Date: May 21, 2026

(54) ELECTRIFIED VEHICLE

(71) Applicant: TOYOTA JIDOSHA KABUSHIKI KAISHA, Toyota-shi (JP)

(72) Inventors: Takashi FUKAYA, Miyoshi-shi (JP); Takahiro HIMENO, Toyota-shi (JP)

(73) Assignee: TOYOTA JIDOSHA KABUSHIKI KAISHA, Toyota-shi (JP)

(21) Appl. No.: 19/280,556

(22) Filed: Jul. 25, 2025

(30) Foreign Application Priority Data
Nov. 15, 2024 (JP) 2024-199412

(51) Int. Cl. B60L 3/00; B60L 50/51

(52) U.S. Cl. CPC B60L 3/003; B60L 50/51; B60L 2210/40

(57) ABSTRACT

When the overcurrent of any phase of the first inverter is detected, the electrified vehicle executes the shutdown process of the first and second inverters, determines which of the first upper arm and the first lower arm of the first overcurrent phase has the short-circuit abnormality based on the sign of the current offset value of the first overcurrent phase of the first inverter, and when the overcurrent of any phase of the second inverter is detected, the electrified vehicle executes the shutdown process of the first and second inverters, and determines which of the second upper arm and the second lower arm of the second overcurrent phase has the short-circuit abnormality based on the sign of the current offset value of the second overcurrent phase of the second inverter.

### CROSS-REFERENCE TO RELATED APPLICATION

This application claims priority to Japanese Patent Application No. 2024-199412 filed on Nov. 15, 2024. The disclosure of the above-identified application, including the specification, drawings, and claims, is incorporated by reference herein in its entirety.

### BACKGROUND

### 1. Technical Field

The present disclosure relates to an electrified vehicle.

### 2. Description of Related Art

In the related art, an electrified vehicle has been proposed that includes a power storage device, a motor including a three-phase open winding, a first inverter, and a second inverter (for example, see Japanese Unexamined Patent Application Publication No. 2022-021849 (JP 2022-021849 A)). The first inverter is connected to a positive electrode-side line and a negative electrode-side line to which the power storage device is connected, and is connected to a first end side of the three-phase open winding. The first inverter includes first upper arms of three phases and first lower arms of three phases. The second inverter is connected to the positive electrode-side line and the negative electrode-side line on the opposite side of the first inverter from the power storage device, and is connected to a second end side of the three-phase open winding. The second inverter includes second upper arms of three phases and second lower arms of three phases. In the electrified vehicle, a current sensor is attached to each phase of the three-phase open winding, and during an H-drive operation in which the motor is driven by the first and second inverters, an abnormality diagnosis of the current sensor of each phase is performed based on the sum of phase currents of the respective phases.

### SUMMARY

In such an electrified vehicle, a case may occur in which overcurrent is detected in any of the phases of the first inverter or the second inverter. In this case, there is a demand for developing a method of determining which of the upper arm and the lower arm of an overcurrent phase that is a phase with overcurrent has a short-circuit abnormality. A main object of an electrified vehicle according to the present disclosure is to enable determination, in a case where overcurrent is detected in any of the phases of the first inverter or the second inverter, of which of an upper arm and a lower arm of a phase with overcurrent has a short-circuit abnormality.

An electrified vehicle according to the present disclosure adopts the following measures to achieve the main object described above. An electrified vehicle according to the present disclosure includes:
a power storage device;
a motor including a three-phase open winding;
a first inverter configured to be connected to a first positive electrode-side line and a first negative electrode-side line to which the power storage device is connected, and to be connected to a first end side of the three-phase open winding, the first inverter including first upper arms of three phases and first lower arms of three phases;
a second inverter configured to be connected to the first positive electrode-side line and the first negative electrode-side line on an opposite side of the first inverter from the power storage device, and to be connected to a second end side of the three-phase open winding, the second inverter including second upper arms of three phases and second lower arms of three phases; and
a control device,
in which the control device is configured to,
in a case where overcurrent is detected in any of the phases of the first inverter, execute a shutdown process of the first inverter and the second inverter, and determine, based on a sign of a current offset value of a first overcurrent phase that is a phase with overcurrent of the first inverter, which of the first upper arm and the first lower arm of the first overcurrent phase has a short-circuit abnormality, and
in a case where overcurrent is detected in any of the phases of the second inverter, execute the shutdown process of the first inverter and the second inverter, and determine, based on a sign of a current offset value of a second overcurrent phase that is a phase with overcurrent of the second inverter, which of the second upper arm and the second lower arm of the second overcurrent phase has a short-circuit abnormality.

In the electrified vehicle according to the present disclosure, the control device is configured to, in a case where overcurrent is detected in any of the phases of the first inverter, execute a shutdown process of the first inverter and the second inverter, and determine, based on a sign of a current offset value of a first overcurrent phase that is a phase with overcurrent of the first inverter, which of the first upper arm and the first lower arm of the first overcurrent phase has a short-circuit abnormality, and
in a case where overcurrent is detected in any of the phases of the second inverter, execute a shutdown process of the first inverter and the second inverter, and determine, based on a sign of a current offset value of a second overcurrent phase that is a phase with overcurrent of the second inverter, which of the second upper arm and the second lower arm of the second overcurrent phase has a short-circuit abnormality.
   In a case where the motor is rotating, when the shutdown process of the first inverter and the second inverter is executed, a current based on a back electromotive force generated due to the rotation of the motor flows through the respective phases of the motor. At this time, since a current offset occurs in the phase including the arm with a short-circuit abnormality, it is possible to determine, based on the sign of the current offset value, which of the upper arm and the lower arm of the overcurrent phase has a short-circuit abnormality.

The electrified vehicle according to the present disclosure may further include:
a first switch provided between the power storage device and the first inverter on the first positive electrode-side line;
a second switch provided between the first inverter and the second inverter on the first positive electrode-side line;
a third switch provided between the power storage device and the first inverter on the first negative electrode-side line;
a fourth switch provided between the first inverter and the second inverter on the first negative electrode-side line;
a fifth switch provided on a second positive electrode-side line that connects the first positive electrode-side line on a side closer to the power storage device than the first switch is and the first positive electrode-side line on a side closer to the second inverter than the second switch is; and
a sixth switch provided on a second negative electrode-side line that connects the first negative electrode-side line on a side closer to the power storage device than the third switch is and the first negative electrode-side line on a side closer to the second inverter than the fourth switch is,
in which the control device is configured to,
in a case where a short-circuit abnormality is detected in any of the first upper arms of the three phases, turn on the third switch, the fourth switch, and the fifth switch, or turn on the fifth switch and the sixth switch, turn on the first upper arms of the three phases, and perform the switching drive of the second inverter,
in a case where a short-circuit abnormality is detected in any of the first lower arms of the three phases, turn on the first switch, the second switch, and the sixth switch, or turn on the fifth switch and the sixth switch, turn on the first lower arms of the three phases, and perform the switching drive of the second inverter,
in a case where a short-circuit abnormality is detected in any of the second upper arms of the three phases, turn on the first switch, the third switch, and the fourth switch, or turn on the first switch, the third switch, and the sixth switch, or turn on the first switch and the third switch, turn on the second upper arms of the three phases, and perform the switching drive of the first inverter, and
in a case where a short-circuit abnormality is detected in any of the second lower arms of the three phases, turn on the first switch, the second switch, and the third switch, or turn on the first switch, the third switch, and the fifth switch, or turn on the first switch and the third switch, turn on the second lower arms of the three phases, and perform the switching drive of the first inverter.
   In this way, the limp home traveling can be performed according to the location of a short-circuit abnormality among the first upper arms of the three phases, the first lower arms of the three phases, the second upper arms of the three phases, and the second lower arms of the three phases.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle according to an embodiment of the present disclosure;

FIG. 2 is a flowchart showing an example of a short-circuit abnormal element detection routine;

FIG. 3A is an explanatory diagram showing an example of waveforms of phase currents of the respective phases when the first upper arm or the first lower arm of the U phase has a short-circuit abnormality;

FIG. 3B is an explanatory diagram showing another example of waveforms of phase currents of the respective phases when the first upper arm or the first lower arm of the U phase has a short-circuit abnormality;

FIG. 4A is an explanatory diagram showing an example of waveforms of phase currents of the respective phases when the second upper arm or the second lower arm of the U phase has a short-circuit abnormality;

FIG. 4B is an explanatory diagram showing an example of waveforms of phase currents of the respective phases when the second upper arm or the second lower arm of the U phase has a short-circuit abnormality;

FIG. 5 is a flowchart showing an example of the limp home control routine; and

FIG. 6 is an explanatory diagram showing an example of a state of the first limp home control.

### DETAILED DESCRIPTION OF EMBODIMENTS

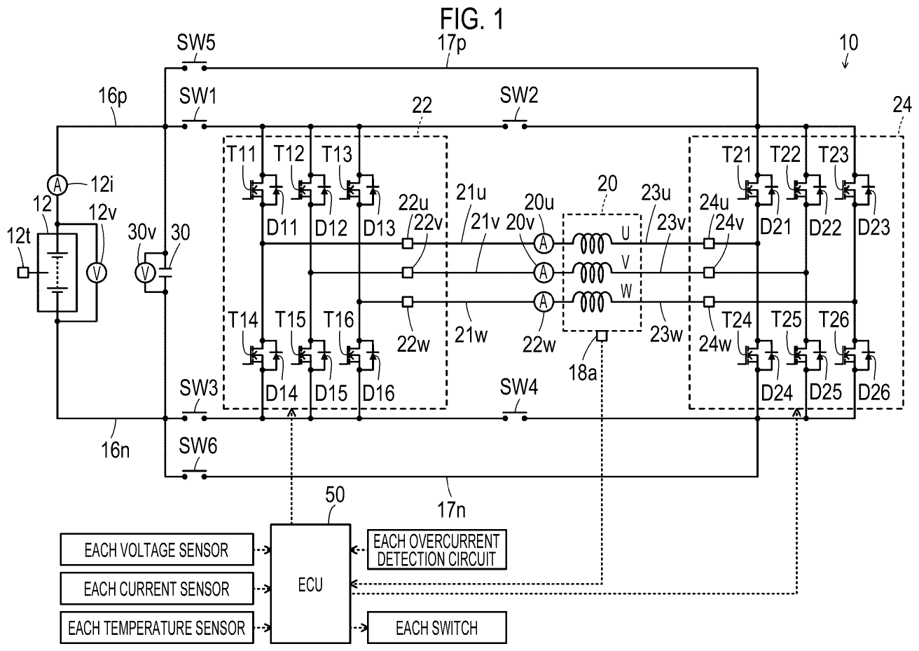

An embodiment for carrying out the present disclosure will be described with reference to the drawings. FIG. 1 is a schematic configuration diagram of a battery electric vehicle 10 according to an embodiment of the present disclosure. As illustrated, the battery electric vehicle 10 of the embodiment includes a battery 12 as a power storage device, a motor 20, first and second inverters 22, 24, first to sixth switches SW1 to SW6, a capacitor 30, and an electronic control unit (hereinafter, referred to as “ECU”) 50 as a control device.

The battery 12 is configured as, for example, a lithium ion secondary battery or a nickel-hydrogen secondary battery, and is connected to the first positive electrode-side line 16p and the first negative electrode-side line 16n. The motor 20 is configured as a three-phase alternating current motor, and includes a rotor in which a permanent magnet is embedded in a rotor core and a stator in which three-phase (U phase, V phase, and W phase) coil (three-phase open winding) is wound around a stator core. The rotor is connected to a drive shaft coupled to drive wheels via a differential gear.

The first and second inverters 22, 24 each include six transistors T11 to T16, T21 to T26 as switching elements, and six diodes D11 to D16, D21 to D26 connected in parallel to the six transistors T11 to T16, T21 to T26, respectively. As the transistors T11 to T16, T21 to T26, for example, a MOSFET or an IGBT is used. The transistors T11 to T16, T21 to T26 are disposed in pairs such that the transistors T11 to T16, T21 to T26 are located on the source side and the sink side with respect to the first positive electrode-side line 16p and the first negative electrode-side line 16n, respectively. The connection point of the transistors T11, T14, the connection point of the transistors T12, T15, and the connection point of the transistors T13, T16 are connected to the first end side of the U phase, V phase, and W phase coils of the motor 20 via the U phase, V phase, and W phase lines 21u, 21v, 21w, respectively. The connection point of the transistors T21, T24, the connection point of the transistors T22, T25, and the connection point of the transistors T23, T26 are connected to the second end side of the U phase, V phase, and W phase coils of the motor 20 via the U phase, V phase, and W phase lines 23u, 23v, 23w, respectively. Hereinafter, the transistors T11 to T13 and the diodes D11 to D13 may be referred to as “first upper arms”, and the transistors T14 to T16 and the diodes D14 to D16 may be referred to as “first lower arms”. In addition, the transistors T21 to T23 and the diodes D21 to D23 may be referred to as “second upper arms”, and the transistors T24 to T26 and the diodes D24 to D26 may be referred to as “second lower arms”. The first inverter 22 further includes overcurrent detection circuits 22u, 22v, 22w that respectively detect overcurrent in the U phase, V phase, and W phase lines 21u, 21v, 21w. The second inverter 24 further includes overcurrent detection circuits 24u, 24v, 24w that respectively detect overcurrent in the U phase, V phase, and W phase lines 23u, 23v, 23w. The overcurrent detection circuits 22u, 22v, 22w, 24u, 24v, 24w are designed so that, in consideration of the attenuation of the current by the RL component of the three-phase coil of the motor 20, when overcurrent is detected on one side (the first inverter 22 side or the second inverter 24 side), overcurrent is not detected on the other side.

The first switch SW1 is provided between the battery 12 and the first inverter 22 on the first positive electrode-side line 16p. The second switch SW2 is provided between the first and second inverters 22, 24 on the first positive electrode-side line 16p. The third switch SW3 is provided between the battery 12 and the first inverter 22 on the first negative electrode-side line 16n. The fourth switch SW4 is provided between the first and second inverters 22, 24 on the first negative electrode-side line 16n. The fifth switch SW5 is provided on a second positive electrode-side line 17p that connects a side closer to the battery 12 than the first switch SW1 on the first positive electrode-side line 16p, and a side closer to the second inverter 24 than the second switch SW2 on the first positive electrode-side line 16p. The sixth switch SW6 is provided on a second negative electrode-side line 17n that connects a side closer to the battery 12 than the third switch SW3 of the first negative electrode-side line 16n, and a side closer to the second inverter 24 than the fourth switch SW4 of the first negative electrode-side line 16n. The capacitor 30 is connected to the side closer to the battery 12 than the first and third switches SW1, SW3 on the first positive electrode-side line 16p and the first negative electrode-side line 16n.

The ECU 50 includes a microcomputer having a CPU, a ROM, a RAM, a flash memory, an input/output port, and a communication port, or various drive circuits and various logic ICs. The ECU 50 receives signals from various sensors. For example, the ECU 50 receives the voltage Vb of the battery 12 from the voltage sensor 12v, the current Ib of the battery 12 from the current sensor 12i, and the temperature Tb of the battery 12 from the temperature sensor 12t. The ECU 50 also receives a rotation position θm of the rotor of the motor 20 from the rotation position sensor 20a, and the phase currents Iu, Iv, Iw of the U phase, V phase, and W phase of the motor 20 from the current sensors 20u, 20v, 20w. The phase currents Iu, Iv, Iw of the U phase, V phase, and W phase are positive values in the direction from the first inverter 22 to the motor 20. The ECU 50 receives signals indicating the presence or absence of overcurrent in the U phase, V phase, and W phase lines 21u, 21v, 21w from the overcurrent detection circuits 22u, 22v, 22w. In addition, the ECU 50 receives signals indicating the presence or absence of overcurrent in the U phase, V phase, and W phase lines 23u, 23v, 23w from the overcurrent detection circuits 24u, 24v, 24w. The ECU 50 also receives the voltage VH of the capacitor 30 from the voltage sensor 30v. The ECU 50 also receives an on/off signal from the power switch, a shift position SP, an accelerator operation amount Acc, a brake pedal position BP, and a vehicle speed V from a vehicle speed sensor. The shift position SP is an operation position of a shift lever from a shift position sensor. The accelerator operation amount Acc is the amount of depression of the accelerator pedal from the accelerator pedal position sensor. The brake pedal position BP is the depression amount of the brake pedal from the brake pedal position sensor.

The ECU 50 outputs various control signals. For example, control signals are output from the ECU 50 to the transistors T11 to T16, T21 to T26 of the first and second inverters 22, 24, and to the first to sixth switches SW1 to SW6. The ECU 50 calculates the state of charge SOC of the battery 12 based on the integrated value of the current Ib of the battery 12, or calculates the rotational speed Nm of the motor 20 based on the rotation position θm of the rotor of the motor 20.

In the battery electric vehicle 10 of the embodiment, the ECU 50 basically turns on the first to fourth switches SW1 to SW4 and turns off the fifth and sixth switches SW5, SW6. Then, the ECU 50 sets the request torque Td* requested for traveling based on the accelerator operation amount Acc and the vehicle speed V. The ECU 50 sets the torque command Tm* of the motor 20 so that the vehicle travels with the set request torque Td*, and performs switching control of the transistors T11 to T16, T21 to T26 of the first and second inverters 22, 24 so that the motor 20 is driven at the torque command Tm*. Hereinafter, the operation of driving the motor 20 by switching of the first and second inverters 22, 24 is referred to as “H-drive”.

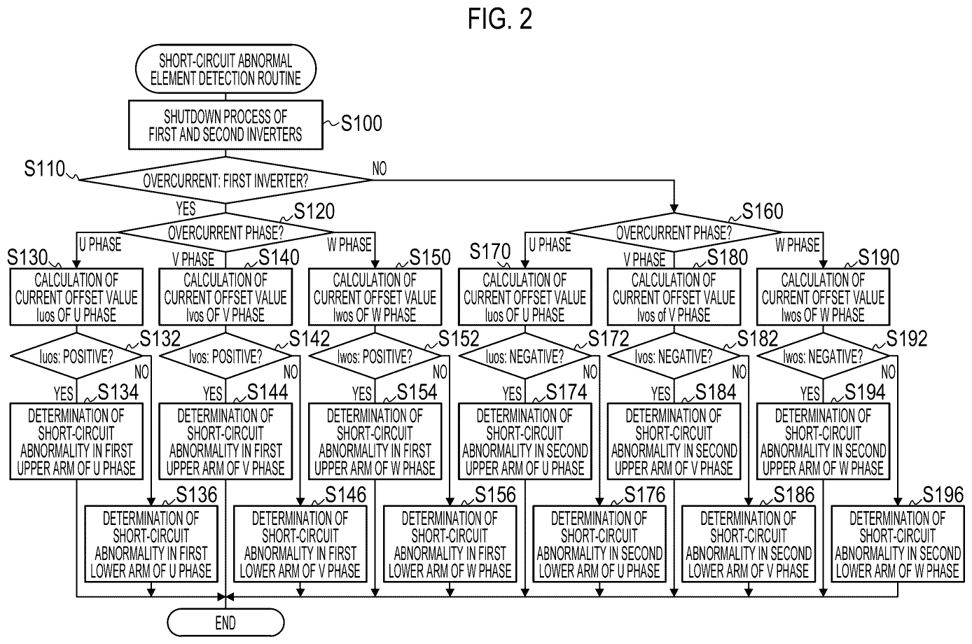

Next, an operation of the battery electric vehicle 10 of the embodiment will be described. In particular, an operation when a short-circuit abnormality has occurred in any of the transistors T11 to T16, T21 to T26 of the first and second inverters 22, 24 during traveling in H-drive will be described. FIG. 2 is a flowchart showing an example of a short-circuit abnormal element detection routine that is executed by the ECU 50. The routine is executed when the ECU 50 detects the overcurrent in any of the U phase, V phase, and W phase lines 21u, 21v, 21w or the U phase, V phase, and W phase lines 23u, 23v, 23w based on the signals from the overcurrent detection circuits 22u, 22v, 22w, 24u, 24v, 24w.

When the routine is executed, the ECU 50 first executes the shutdown process of the first and second inverters 22, 24, that is, controls the first and second inverters 22, 24 so that all of the transistors T11 to T16, T21 to T26 are turned off (S100). When the shutdown process of the first and second inverters 22, 24 is executed during traveling (while the motor 20 is rotating), a current based on a back electromotive force generated due to the rotation of the motor 20 flows through the respective phases of the motor 20.

Next, it is determined in which of the first inverter 22 (overcurrent detection circuits 22u, 22v, 22w) and the second inverter 24 (overcurrent detection circuits 24u, 24v, 24w) the overcurrent is detected (S110). When it is determined that the overcurrent is detected in the first inverter 22, it is determined in which of the overcurrent detection circuits 22u, 22v, 22w the overcurrent is detected (which of the U phase, the V phase, and the W phase is the overcurrent phase) (S120).

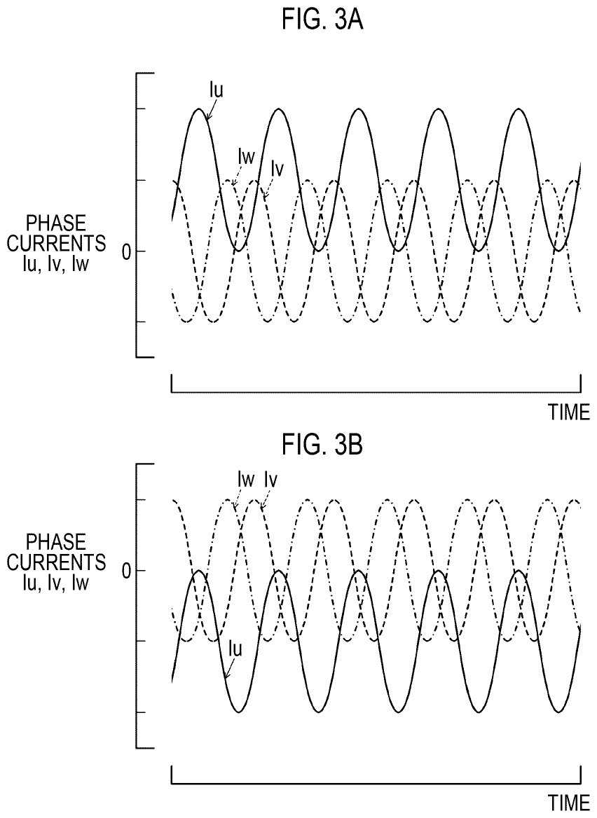

When it is determined that the overcurrent is detected in the overcurrent detection circuit 22u of the U phase in S120 (the U phase is the overcurrent phase), the offset value Iuos of the phase current Iu of the U phase is calculated (S130), and the sign of the calculated offset value Iuos is examined (S132). Here, the offset value Iuos is obtained by performing a low-pass filter (LPF) on the phase current Iu when the shutdown process of the first and second inverters 22, 24 is executed, for example. FIGS. 3A and 3B are explanatory diagrams showing examples of waveforms of phase currents Iu, Iv, Iw of the respective phases when the first upper arm (transistor T11) or the first lower arm (transistor T14) of the U phase has a short-circuit abnormality. FIG. 3A shows a case where the first upper arm of the U phase has a short-circuit abnormality, and FIG. 3B shows a case where the first lower arm of the U phase has a short-circuit abnormality. FIGS. 3A and 3B are obtained by analysis. As shown in FIG. 3A, in a case where the first upper arm of the U phase has the short-circuit abnormality, the phase current Iu is offset to the positive side. On the other hand, as shown in FIG. 3B, in a case where the first lower arm has the short-circuit abnormality, the phase current Iu is offset to the negative side.

Based on the above, when it is determined in S132 that the sign of the offset value Iuos is positive, it is determined that the first upper arm (transistor T11) of the U phase has the short-circuit abnormality (S134), and the routine ends. On the other hand, when it is determined that the sign of the offset value Iuos is negative, it is determined that the first lower arm (transistor T14) of the U phase has the short-circuit abnormality (S136), and the routine ends. In this way, it is possible to determine which of the first upper arm and the first lower arm of the U phase has the short-circuit abnormality.

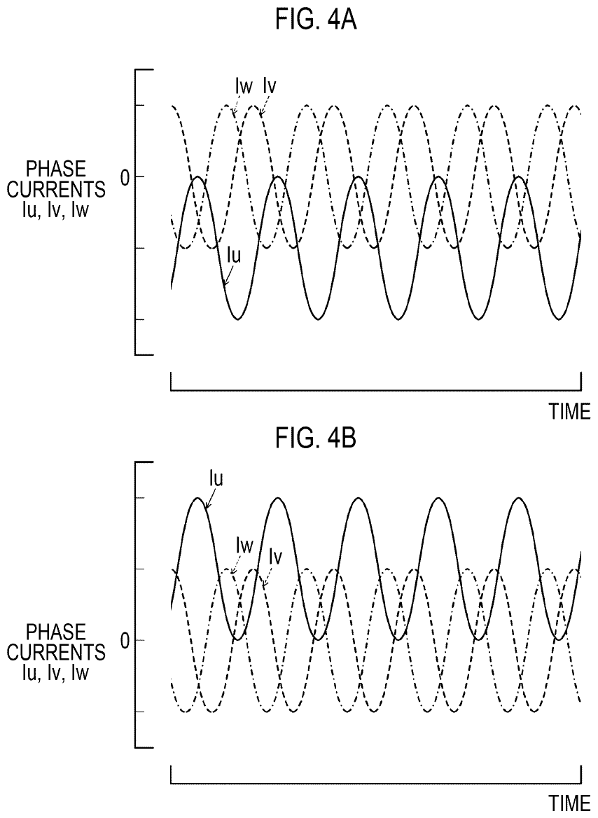

When it is determined in S120 that the overcurrent is detected in the overcurrent detection circuit 22v of the V phase (it is determined that the V phase is the overcurrent phase), the offset value Ivos of the phase current Iv of the V phase is calculated (S140), and the sign of the calculated offset value Ivos is examined (S142). Here, the offset value Ivos is obtained in the same manner as the offset value Iuos. In addition, the sign of the offset value Ivos is the same as in FIGS. 4A and 4B. Therefore, when it is determined that the sign of the offset value Ivos is positive, it is determined that the first upper arm (transistor T12) of the V phase has the short-circuit abnormality (S144), and the routine ends. On the other hand, when it is determined that the sign of the offset value Ivos is negative, it is determined that the first lower arm (transistor T15) of the V phase has the short-circuit abnormality (S146), and the routine ends. In this way, it is possible to determine which of the first upper arm and the first lower arm of the V phase has the short-circuit abnormality.

When it is determined in S120 that the overcurrent is detected in the overcurrent detection circuit 22w of the W phase (the W phase is the overcurrent phase), the offset value Iwos of the phase current Iw of the W phase is calculated (S150), and the sign of the calculated offset value Iwos is examined (S152). Here, the offset value Iwos is obtained in the same manner as the offset value Iuos. In addition, the sign of the offset value Iwos is the same as in FIGS. 4A and 4B. Therefore, when it is determined that the sign of the offset value Iwos is positive, it is determined that the first upper arm (transistor T13) of the W phase has the short-circuit abnormality (S154), and the routine ends. On the other hand, when it is determined that the sign of the offset value Iwos is negative, it is determined that the first lower arm (transistor T16) of the W phase has the short-circuit abnormality (S156), and the routine ends. In this way, it is possible to determine which of the first upper arm and the first lower arm of the W phase has the short-circuit abnormality.

When it is determined in S110 that the overcurrent is detected in the second inverter 24, it is determined in which of the overcurrent detection circuits 24u, 24v, 24w the overcurrent is detected (which of the U phase, the V phase, and the W phase is the overcurrent phase) (S160). When it is determined that the overcurrent is detected in the overcurrent detection circuit 24u of the U phase (the U phase is the overcurrent phase), the offset value Iuos of the phase current Iu of the U phase is calculated (S170), and the sign of the calculated offset value Iuos is examined (S172). FIGS. 4A and 4B are explanatory diagrams showing examples of waveforms of phase currents Iu, Iv, Iw of the respective phases when the second upper arm (transistor T21) or the second lower arm (transistor T24) of the U phase has a short-circuit abnormality. FIG. 4A shows a case where the second upper arm of the U phase has a short-circuit abnormality, and FIG. 4B shows a case where the second lower arm of the U phase has a short-circuit abnormality. FIGS. 4A and 4B are obtained by analysis. As shown in FIG. 4A, in a case where the first upper arm of the U phase has the short-circuit abnormality, the phase current Iu is offset to the negative side. On the other hand, as shown in FIG. 4B, in a case where the first lower arm has the short-circuit abnormality, the phase current Iu is offset to the positive side.

Based on the above, when it is determined in S172 that the sign of the offset value Iuos is negative, it is determined that the second upper arm (transistor T21) of the U phase has the short-circuit abnormality (S174), and the routine ends. On the other hand, when it is determined that the sign of the offset value Iuos is positive, it is determined that the second lower arm (transistor T24) of the U phase has the short-circuit abnormality (S176), and the routine ends. In this way, it is possible to determine which of the second upper arm and the second lower arm of the U phase has the short-circuit abnormality.

When it is determined in S160 that the overcurrent is detected in the overcurrent detection circuit 24v of the V phase (the V phase is the overcurrent phase), the offset value Ivos of the phase current Iv of the V phase is calculated (S180), and the sign of the calculated offset value Ivos is examined (S182). Here, the sign of the offset value Ivos is the same as in FIGS. 4A and 4B. Therefore, when it is determined that the sign of the offset value Ivos is negative, it is determined that the second upper arm (transistor T22) of the V phase has the short-circuit abnormality (S184), and the routine ends. On the other hand, when it is determined that the sign of the offset value Ivos is positive, it is determined that the second lower arm (transistor T25) of the V phase has the short-circuit abnormality (S186), and the routine ends. In this way, it is possible to determine which of the second upper arm and the second lower arm of the V phase has the short-circuit abnormality.

When it is determined in S160 that the overcurrent is detected in the overcurrent detection circuit 24w of the W phase (the W phase is the overcurrent phase), the offset value Iwos of the phase current Iw of the W phase is calculated (S190), and the sign of the calculated offset value Iwos is examined (S192). Here, the sign of the offset value Iwos is the same as in FIGS. 4A and 4B. Therefore, when it is determined that the sign of the offset value Iwos is negative, it is determined that the second upper arm (transistor T23) of the W phase has the short-circuit abnormality (S194), and the present routine ends. On the other hand, when it is determined that the sign of the offset value Iwos is positive, it is determined that the second lower arm (transistor T26) of the W phase has the short-circuit abnormality (S196), and the routine ends. In this way, it is possible to determine which of the second upper arm and the second lower arm of the W phase has the short-circuit abnormality. With the short-circuit abnormal element detection routine of FIG. 2, the transistor with the short-circuit abnormality can be specified from the transistors T11 to T16, T21 to T26 of the first and second inverters 22, 24.

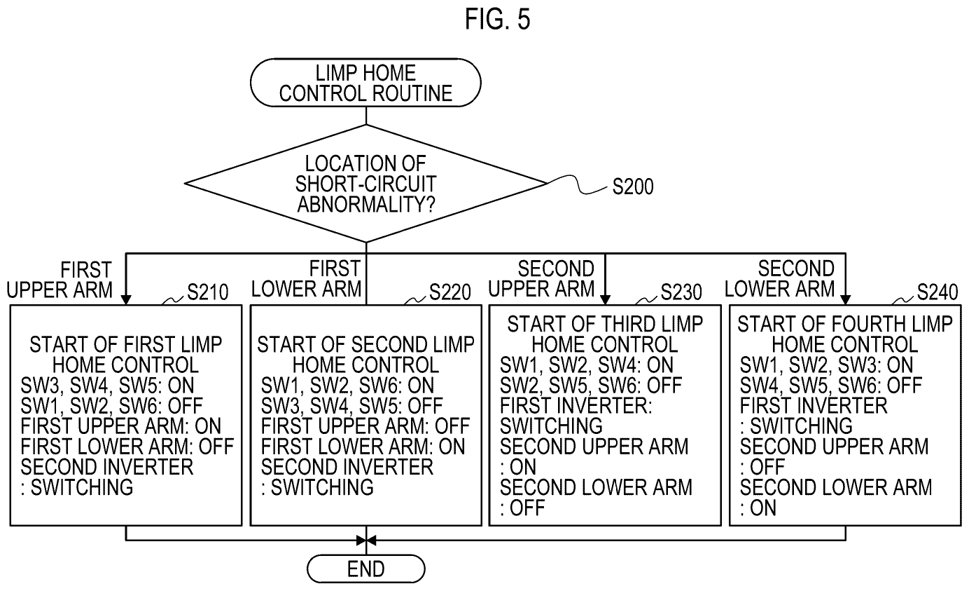

Next, an operation when the ECU 50 detects a short-circuit abnormality in any of the transistors T11 to T16, T21 to T26 of the first and second inverters 22, 24 will be described. FIG. 5 is a flowchart showing an example of the limp home control routine that is executed by the ECU 50. The routine is executed when the ECU 50 detects a short-circuit abnormality in any of the transistors T11 to T16, T21 to T26 of the first and second inverters 22, 24.

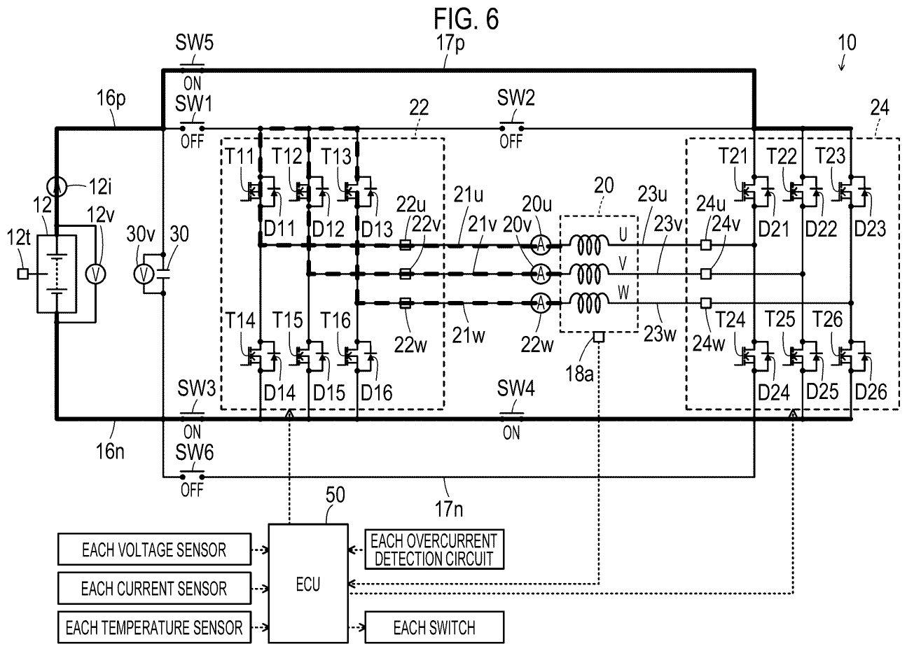

When the routine is executed, the ECU 50 determines in which of the transistors T11 to T16, T21 to T26 of the first and second inverters 22, 24 the short-circuit abnormality is detected (S200). Then, when it is determined that the short-circuit abnormality is detected in any of the first upper arms (transistors T11 to T13) of the three phases, the first limp home control is started (S210), and the routine ends. FIG. 6 is an explanatory diagram showing an example of a state of the first limp home control. As shown in FIG. 6, in the first limp home control, the third, fourth, and fifth switches SW3, SW4, SW5 are turned on. At the same time, the first, second, and sixth switches SW1, SW2, SW6 are turned off, and the first upper arms (including the transistor with the short-circuit abnormality) of the three phases are turned on. At the same time, the first lower arms of the three phases are turned off, and the transistors T21 to T26 of the second inverter 24 are switched. The third, fourth, and fifth switches SW3, SW4, SW5 are turned on. At the same time, by turning off the first, second, and sixth switches SW1, SW2, SW6, the voltage of the battery 12 is applied only to the second inverter 24 of the first and second inverters 22, 24 (see the bold solid line in FIG. 6). In addition, by turning on the first upper arms of the three phases and turning off the first lower arms of the three phases, the first inverter 22 side of the three-phase coil of the motor 20 is neutralized (see the bold broken line in FIG. 6). Hereinafter, the operation of providing the neutral point of the motor 20 by one of the first and second inverters 22, 24 and driving the motor 20 by the other inverter is referred to as “Y-drive”. When a short-circuit abnormality occurs in any of the first upper arms of the three phases, the limp home traveling can be performed by the Y-drive of the first limp home control.

When it is determined in S200 that the short-circuit abnormality is detected in any of the first lower arms (transistors T14 to T16) of the three phases, the second limp home control is started (S220), and the routine ends. In the second limp home control, the first, second, and sixth switches SW1, SW2, SW6 are turned on. At the same time, the third, fourth, and fifth switches SW3, SW4, SW5 are turned off, and the first lower arms (including the transistor with the short-circuit abnormality) of the three phases are turned on. At the same time, the first upper arms of the three phases are turned off, and the transistors T21 to T26 of the second inverter 24 are switched. The first, second, and sixth switches SW1, SW2, SW6 are turned on. At the same time, by turning off the third, fourth, and fifth switches SW3, SW4, SW5, the voltage of the battery 12 is applied only to the second inverter 24 of the first and second inverters 22, 24. In addition, by turning on the first lower arms of the three phases and turning off the first upper arms of the three phases, the first inverter 22 side of the three-phase coil of the motor 20 is neutralized. When a short-circuit abnormality occurs in any of the first lower arms of three phases, the limp home traveling can be performed by the Y-drive of the second limp home control.

When it is determined in S200 that the short-circuit abnormality is detected in any of the second upper arms (transistors T21 to T23) of the three phases, the third limp home control is started (S230), and the routine ends. In the third limp home control, the first, third, and fourth switches SW1, SW3, SW4 are turned on. At the same time, the second, fifth, and sixth switches SW2, SW5, SW6 are turned off, and the second upper arms (including the transistor with the short-circuit abnormality) of the three phases are turned on. At the same time, the second lower arms of the three phases are turned off, and the transistors T11 to T16 of the first inverter 22 are switched. By turning on the first, third, and fourth switches SW1, SW3, SW4 and turning off the second, fifth, and sixth switches SW2, SW5, SW6, the voltage of the battery 12 is applied only to the first inverter 22. In addition, by turning on the second upper arms of the three phases and turning off the second lower arms of the three phases, the second inverter 24 side of the three-phase coil of the motor 20 is neutralized. When a short-circuit abnormality occurs in any of the second upper arms of the three phases, the limp home traveling can be performed by the Y-drive of the third limp home control.

When it is determined in S200 that the short-circuit abnormality is detected in any of the second lower arms (transistors T24 to T26) of the three phases, the fourth limp home control is started (S240), and the routine ends. In the fourth limp home control, the first, second, and third switches SW1, SW2, SW3 are turned on. At the same time, the fourth, fifth, and sixth switches SW4, SW5, SW6 are turned off, and the second lower arms (including the transistor with the short-circuit abnormality) of the three phases are turned on. At the same time, the second upper arms of the three phases are turned off, and the transistors T11 to T16 of the first inverter 22 are switched. By turning on the first, second, and third switches SW1, SW2, SW3 and turning off the fourth, fifth, and sixth switches SW4, SW5, SW6, the voltage of the battery 12 is applied only to the first inverter 22. In addition, by turning on the second lower arms of the three phases and turning off the second upper arms of the three phases, the second inverter 24 side of the three-phase coil of the motor 20 is neutralized. When a short-circuit abnormality occurs in any of the second lower arms of three phases, the limp home traveling can be performed by the Y-drive of the fourth limp home control.

In the battery electric vehicle 10 of the embodiment described above, when the overcurrent is detected in any of the phases of the first inverter 22, the shutdown process of the first and second inverters 22, 24 is executed. The battery electric vehicle 10 determines, based on the sign of the current offset value of the phase with overcurrent (first overcurrent phase) of the first inverter 22, which of the first upper arm and the first lower arm of the first overcurrent phase has the short-circuit abnormality. When the overcurrent is detected in any of the phases of the second inverter 24, the battery electric vehicle 10 executes the shutdown process of the first and second inverters 22, 24. The battery electric vehicle 10 determines, based on the sign of the current offset value of the phase with overcurrent (second overcurrent phase) of the second inverter 24, which of the second upper arm and the second lower arm of the second overcurrent phase has the short-circuit abnormality. In this way, it is possible to determine which of the upper arm and the lower arm of the first overcurrent phase or the second overcurrent phase has the short-circuit abnormality. That is, the transistor with the short-circuit abnormality can be specified.

In the above-described embodiment, in the first limp home control, the third, fourth, and fifth switches SW3, SW4, SW5 are turned on. At the same time, the first, second, and sixth switches SW1, SW2, SW6 are turned off. However, the fifth and sixth switches SW5, SW6 are turned on. At the same time, the first, second, third, and fourth switches SW1, SW2, SW3, SW4 may be turned off.

In the above-described embodiment, in the second limp home control, the first, second, and sixth switches SW1, SW2, SW6 are turned on. At the same time, the third, fourth, and fifth switches SW3, SW4, SW5 are turned off. However, the fifth and sixth switches SW5, SW6 are turned on. At the same time, the first, second, third, and fourth switches SW1, SW2, SW3, SW4 may be turned off.

In the above-described embodiment, in the third limp home control, the first, third, and fourth switches SW1, SW3, SW4 are turned on. At the same time, the second, fifth, and sixth switches SW2, SW5, SW6 are turned off. However, the first, third, and sixth switches SW1, SW3, SW6 are turned on. At the same time, the second, fourth, and fifth switches SW2, SW4, SW5 may be turned off. In addition, the first and third switches SW1, SW3 are turned on. At the same time, the second, fourth, fifth, and sixth switches SW2, SW4, SW5, SW6 may be turned off.

In the above-described embodiment, in the fourth limp home control, the first, second, and third switches SW1, SW2, SW3 are turned on. At the same time, the fourth, fifth, and sixth switches SW4, SW5, SW6 are turned off. However, the first, third, and fifth switches SW1, SW3, SW5 are turned on. At the same time, the second, fourth, and sixth switches SW2, SW4, SW6 may be turned on. In addition, the first and third switches SW1, SW3 are turned on. At the same time, the second, fourth, fifth, and sixth switches SW2, SW4, SW5, SW6 may be turned off.

In the above-described embodiment, any one of the first to fourth limp home controls is executed when the short-circuit abnormality is detected in any of the transistors T11 to T16, T21 to T26 of the first and second inverters 22, 24. However, a part of the limp home controls may be executed, or none of the limp home controls may be executed.

In the above-described embodiment, the battery electric vehicle 10 is provided with the second positive electrode-side line 17p and the fifth switch SW5, and the second negative electrode-side line 17n and the sixth switch SW6, but the present disclosure is not limited thereto. For example, the second positive electrode-side line 17p and the fifth switch SW5, and the second negative electrode-side line 17n and the sixth switch SW6 may not be provided.

In the above-described embodiment, the configuration of the battery electric vehicle 10 is used, but the present disclosure is not limited thereto. For example, the configuration of a hybrid electric vehicle that further includes an engine in addition to the same hardware configuration as the battery electric vehicle 10 may be used. In addition, the configuration of a fuel cell electric vehicle that further includes a fuel cell in addition to the same hardware configuration as the battery electric vehicle 10 may be used.

Although the embodiment for implementing the above-described disclosure has been described, the above-described disclosure is not limited to the embodiment, and can be implemented in various forms within the scope of the spirit of the above-described disclosure.

The present disclosure can be used in a manufacturing industry of an electrified vehicle.

What is claimed is:

1. An electrified vehicle comprising:
a power storage device;
a motor including a three-phase open winding;
a first inverter configured to be connected to a first positive electrode-side line and a first negative electrode-side line to which the power storage device is connected, and to be connected to a first end side of the three-phase open winding, the first inverter including first upper arms of three phases and first lower arms of three phases;
a second inverter configured to be connected to the first positive electrode-side line and the first negative electrode-side line on an opposite side of the first inverter from the power storage device, and to be connected to a second end side of the three-phase open winding, the second inverter including second upper arms of three phases and second lower arms of three phases; and
a control device, wherein the control device is configured to,
in a case where overcurrent is detected in any of the phases of the first inverter, execute a shutdown process of the first inverter and the second inverter, and determine, based on a sign of a current offset value of a first overcurrent phase that is a phase with overcurrent of the first inverter, which of the first upper arm and the first lower arm of the first overcurrent phase has a short-circuit abnormality, and
in a case where overcurrent is detected in any of the phases of the second inverter, execute the shutdown process of the first inverter and the second inverter, and determine, based on a sign of a current offset value of a second overcurrent phase that is a phase with overcurrent of the second inverter, which of the second upper arm and the second lower arm of the second overcurrent phase has a short-circuit abnormality.

2. The electrified vehicle according to claim 1, further comprising:
a first switch provided between the power storage device and the first inverter on the first positive electrode-side line;
a second switch provided between the first inverter and the second inverter on the first positive electrode-side line;
a third switch provided between the power storage device and the first inverter on the first negative electrode-side line;
a fourth switch provided between the first inverter and the second inverter on the first negative electrode-side line;
a fifth switch provided on a second positive electrode-side line that connects the first positive electrode-side line on a side closer to the power storage device than the first switch is and the first positive electrode-side line on a side closer to the second inverter than the second switch is; and
a sixth switch provided on a second negative electrode-side line that connects the first negative electrode-side line on a side closer to the power storage device than the third switch is and the first negative electrode-side line on a side closer to the second inverter than the fourth switch is, wherein the control device is configured to,
in a case where a short-circuit abnormality is detected in any of the first upper arms of the three phases, turn on the third switch, the fourth switch, and the fifth switch, or turn on the fifth switch and the sixth switch, turn on the first upper arms of the three phases, and perform switching drive of the second inverter,
in a case where a short-circuit abnormality is detected in any of the first lower arms of the three phases, turn on the first switch, the second switch, and the sixth switch, or turn on the fifth switch and the sixth switch, turn on the first lower arms of the three phases, and perform the switching drive of the second inverter,
in a case where a short-circuit abnormality is detected in any of the second upper arms of the three phases, turn on the first switch, the third switch, and the fourth switch, or turn on the first switch, the third switch, and the sixth switch, or turn on the first switch and the third switch, turn on the second upper arms of the three phases, and perform the switching drive of the first inverter, and
in a case where a short-circuit abnormality is detected in any of the second lower arms of the three phases, turn on the first switch, the second switch, and the third switch, or turn on the first switch, the third switch, and the fifth switch, or turn on the first switch and the third switch, turn on the second lower arms of the three phases, and perform the switching drive of the first inverter.
